(19) United States
(12) Patent Application Publication
(10) Pub. No.: US 2025/0073681 A1
(43) Pub. Date: Mar. 6, 2025

(54) HIGH PRESSURE REVERSE WATER GAS SHIFT REACTION WITH LOW SELECTIVITY TO METHANE

(71) Applicants: SAUDI ARABIAN OIL COMPANY, Dhahran (SA); King Abdullah University of Science and Technology, Thuwal-Jeddah (SA)

(72) Inventors: Jorge Gascon Sabate, Thuwal (SA); Jean Marcel Ribeiro Gallo, Thuwal (SA)

(73) Assignees: SAUDI ARABIAN OIL COMPANY, Dhahran (SA); King Abdullah University of Science and Technology, Thuwal-Jeddah (SA)

(21) Appl. No.: 18/459,211

(22) Filed: Aug. 31, 2023

(51) Int. Cl. B01J 23/08; B01J 23/04; B01J 37/02; B01J 37/03; B01J 37/08; B01J 37/14; C01B 32/40

(52) U.S. Cl. CPC B01J 23/08; B01J 23/04; B01J 37/0201; B01J 37/031; B01J 37/088; B01J 37/14; C01B 32/40

(57) ABSTRACT

A composition of an indium oxide catalyst including an alkali dopant and a method for producing an indium oxide catalyst including an alkali dopant. The alkali dopant may include a cation of Li⁺, Na⁺, K⁺, Rb⁺, Cs⁺, and Fr⁺. The method for producing the indium oxide catalyst including an alkali dopant includes mixing a solution of an indium salt with a base to form precipitated indium hydroxide, contacting the precipitated indium hydroxide with a solution including an alkali metal salt to produce an indium hydroxide solution, and calcinating the indium hydroxide solution to form indium oxide; thereby forming the indium oxide catalyst including an alkali dopant.

### BACKGROUND

Carbon dioxide (CO₂) can be converted to carbon monoxide (CO) through a process called reverse water gas shift reaction (RWGS). CO is a useful feedstock for methanol synthesis, liquid hydrocarbon production, and the production of other specialty chemicals. Typically, RWGS reactions are performed at low (ambient) pressure and high temperature. The RWGS reaction is usually conducted at ambient pressure since the methanation reaction (conversion of carbon oxides and hydrogen to methane) is favored at high-pressure. Also, the reaction must be conducted at high temperatures (above 500° C.) when a non-noble-metal catalyst is used.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composition of an indium oxide catalyst comprising an alkali dopant.

Embodiments disclosed herein also relate to a method for producing an indium oxide catalyst including an alkali dopant, including the steps of: mixing a solution of an indium salt with a base to form precipitated indium hydroxide, contacting the precipitated indium hydroxide with a solution including an alkali metal salt to produce an indium hydroxide solution, and calcinating the indium hydroxide solution to form indium oxide; thereby forming the indium oxide catalyst including an alkali dopant.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIG. 1A shows a method in accordance with one or more embodiments herein.

FIG. 1B shows an alternative method in accordance with one or more embodiments herein.

FIG. 2 shows a process to produce carbon monoxide in accordance with one or more embodiments herein.

FIG. 3A shows RWGS reaction of Examples 1-5 at 400° C., 50 bar, and 15,000 mL/g/h H₂/CO₂ at a 4:1 molar ratio feed gas.

FIG. 3B shows RWGS reaction of Comparative Examples 1-5 at 400° C., 50 bar, and 15,000 mL/g/h H₂/CO₂ at a 4:1 molar ratio feed gas.

FIG. 3C shows RWGS reaction of Examples 1-5 at ambient conditions.

FIG. 4A shows RWGS reactions at various reaction conditions with Example 3 as the catalyst.

FIG. 4B shows RWGS reactions at various reaction conditions with Example 1 as the catalyst.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” “about,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

In the following description of the figures, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein generally relate to an indium oxide (In₂O₃) catalyst composition containing an alkali dopant. One or more embodiments also relate to a method to produce an In₂O₃ catalyst composition containing an alkali dopant. Additionally, one or more embodiments relate to a process for reacting an In₂O₃ catalyst composition containing an alkali dopant in a RWGS reaction to form CO.

A few examples of catalysts for high-pressure RWGS have been previously reported, however, with significant formation of methane. In cases where methane formation is hindered, these catalysts still require relatively high temperatures (above 500° C.)

Therefore, a need exists for an improved In₂O₃ catalyst which increases the conversion rate of CO₂ to CO while minimizing the selectivity to undesirable side products, for example methane (CH₄) or methanol (CH₃OH). As used herein, the term “selectivity” of a catalyst is the ability to produce a product, desirable or undesirable, and the term “conversion” refers to the amount of a reactant which has reacted. Doping of an In₂O₃ catalyst with an alkali metal according to one or more embodiments presented herein produces a catalyst composition which maximizes CO production in a RWGS reaction that is performed at high pressure (i.e., above about 30 bar) and low temperature (i.e., below about) 500°.

### Alkali-Doped Indium Oxide Catalyst Composition

As noted above, one or more embodiments of the present disclosure relate to an indium oxide (In₂O₃) catalyst composition containing an alkali dopant. In one or more embodiments, indium hydroxide [In(OH)₃], In₂O₃, or a mixture thereof, may be prepared as a starting point for producing an alkali-doped In₂O₃ catalyst composition. The In(OH)₃ and In₂O₃ compounds, or a mixture thereof, may be obtained commercially or produced according to methods provided in later sections.

In general, the use of an In₂O₃ catalyst in an RWGS reaction has high selectivity to CH₃OH production and relatively low CO production at low reaction temperatures and high reaction pressures. Therefore, when CO is the desired product, high reaction temperatures, and low reaction pressures are typically required.

In₂O₃ catalyst doped with an alkali metal according to embodiments herein provides improved selectivity for enhanced CO production at low or high pressures (i.e., from ambient pressure to 50 bar) and moderate temperatures (less than about 500° C.) compared to the In₂O₃ catalyst alone.

The term “dopant” refers to a substance added to a composition to modify or improve the properties of the composition. Specifically, a dopant according to embodiments herein refers to an alkali metal which is added to In(OH)₃ or In₂O₃ catalyst to produce an alkali-doped In₂O₃ catalyst.

In one or more embodiments, an alkali-dopant may be any alkali metal cation selected from group one of the periodic table, including lithium (Li⁺), sodium (Na⁺), potassium (K⁺), rubidium (Rb⁺), cesium (Cs⁺), francium (Fr⁺), or combinations therein.

In one or more embodiments, an alkali-dopant may be added to an In₂O₃ catalyst to produce an alkali-doped In₂O₃ catalyst in an amount in the range of from about 0.5 wt. % to about 10 wt. % based on the total weight of the catalyst, such as a lower limit selected from any one of 0.5, 2, and 5 wt. %, to an upper limit selected from any one of 7, 9 and 10 wt. %, where any lower limit may be paired with any upper limit.

In one or more embodiments, the alkali-doped In₂O₃ catalyst may have a particle size in the range of from about 10 nm to about 200 nm, such as a lower limit selected from any one of 10, 25, and 50 nm, to an upper limit selected from any one of 75, 100 and 200 nm, where any lower limit may be paired with any upper limit. The particle size of the alkali-doped In₂O₃ catalyst may be isolated or formed from larger aggregates.

In one or more embodiments, the alkali-doped In₂O₃ catalyst may be amorphous, or have cubic, or hexagonal crystal unit cells, or mixtures thereof.

In one or more embodiments, the alkali-doped In₂O₃ catalyst may have a surface area in the range of from about 7 to about 55 m²/g, such as a lower limit selected from any one of 7, 10, 15 and 20 m²/g to an upper limit selected from any one of 25, 50, and 55 m²/g.

### Method for Producing Alkali-Doped Catalyst Composition

As noted above, one or more embodiments also relate to a method to produce an In₂O₃ catalyst composition containing an alkali dopant. In one or more embodiments, the method for producing an alkali-doped In₂O₃ catalyst includes preparing indium hydroxide, impregnating the indium hydroxide with a solution of an alkali metal salt, and then calcinating to form an In₂O₃ catalyst containing an alkali dopant.

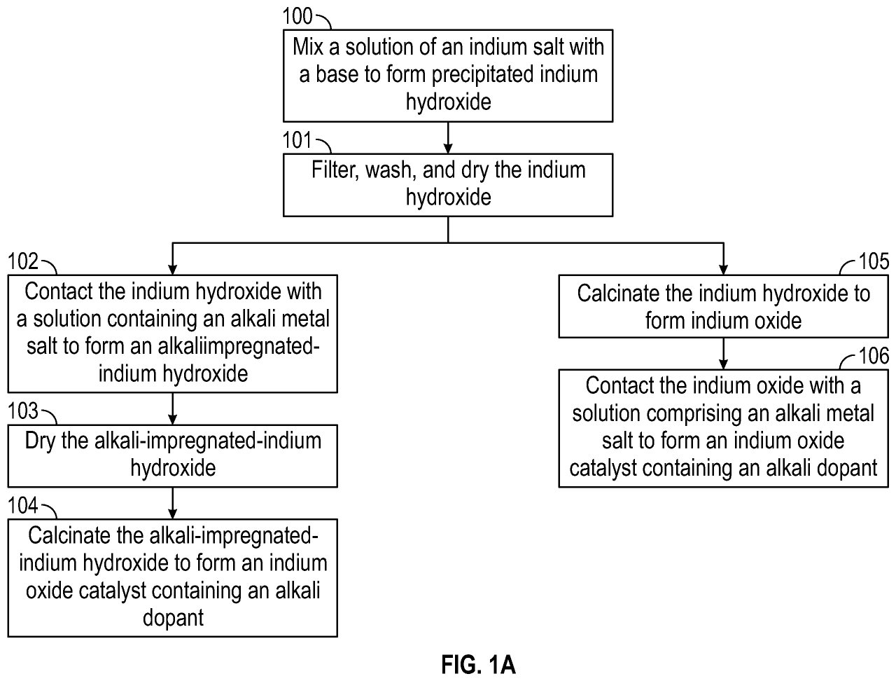

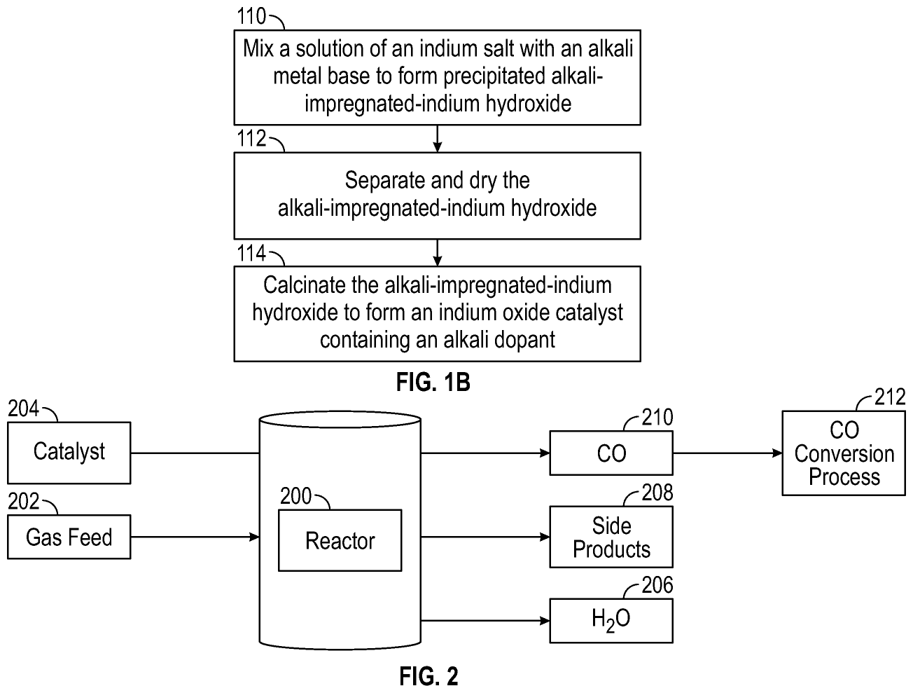

FIG. 1A illustrates a method for producing an In₂O₃ catalyst containing an alkali dopant according to one or more embodiments. In one or more embodiments, the method for producing an In₂O₃ catalyst containing an alkali dopant includes preparing indium hydroxide by mixing a solution of an indium salt with a base. In FIG. 1A, step 100, a solution of an indium salt is mixed with a base to form precipitated indium hydroxide.

The mixing of an indium salt solution with a base to form precipitated indium hydroxide may be done using any method known in the art, for example a simple stirring mechanism such as a stir bar, high shear mixer, or a shaker may be used.

The indium salt may be any soluble indium compound including, but not limited to, indium nitrate, indium acetate, indium chloride, indium oxalate, or indium sulfate under any hydration form. The indium precursor may be present as a mixture of one or more of the indium compounds.

The solution of an indium salt may have a concentration suitable to reach the maximum solubility of the salt in the reaction solvent. As will be appreciated by those skilled in the art, the solubility of the indium salt varies based on the salt and solvent(s) used. For instance, for reactions in water using indium nitrate, the concentration may be between 0.01 M and 4.00 M. However, this concentration range will change from salt-to-salt, so the range is used for illustrative purposes only. Thus, a suitable concentration to fully saturate the solvent may be used in each reaction.

The solution of an indium salt may be combined with a base to form precipitated indium hydroxide. Examples of the base include, but are not limited to, ammonium hydroxide, an alkali metal hydroxide, or a quaternary ammonium hydroxide, or mixtures thereof.

In one or more embodiments, the base is used to control the pH of the solution to promote the precipitation of indium hydroxide. The pH of solution may be in a range of from about 3 to about 12, such as a lower limit selected from any one of 3, 4, 6 and 7, to an upper limit selected from any one of 9, 10, and 12.

Upon combining the solution of an indium salt with the base, precipitated indium hydroxide is formed. Keeping with FIG. 1A, in step 101 the indium hydroxide is then separated by filtration, centrifugation or decantation, washed with water, and dried.

The drying of indium hydroxide may be conducted at a temperature in a range of from about 20° C. to about 120° C., such as a lower limit selected from any one of 20, 25, and 50 to an upper limit selected from any one of 60, 75, 100 and 120° C., where any lower limit may be paired with any upper limit.

The drying of indium hydroxide may be conducted for a range of from about 1 h to about 15 h, such as a lower limit selected from any one of 1, 5, and 7 h to an upper limit selected from any one of 10, 12, and 15 h, where any lower limit may be paired with any upper limit.

In one embodiment, the method for producing an alkali-doped In₂O₃ catalyst includes contacting the indium hydroxide with a solution containing an alkali metal salt to form an alkali-impregnated-indium hydroxide as shown in step 102 of FIG. 1A.

In one or more embodiments, the alkali metal salt may be an alkali metal nitrate, an alkali metal chloride, an alkali metal sulfate, or an alkali metal carbonate. For example, the alkali metal nitrate may be lithium nitrate, sodium nitrate, potassium nitrate, rubidium nitrate, cesium nitrate, or combinations thereof. The alkali metal chloride may be lithium chloride, sodium chloride, potassium chloride, rubidium chloride, cesium chloride, or combinations thereof. The alkali metal nitrate may be lithium nitrate, sodium nitrate, potassium nitrate, rubidium nitrate, cesium nitrate, or combinations thereof. The alkali metal sulfate may be lithium sulfate, sodium sulfate, potassium sulfate, rubidium sulfate, cesium sulfate, or combinations thereof. The alkali metal carbonate may be lithium carbonate, sodium carbonate, potassium carbonate, rubidium carbonate, cesium carbonate, or combinations thereof.

The alkali metal salt solution may have a concentration in a range of from about 0.01 M to about 4 M, such as a lower limit selected from any one of 0.01, 0.1, 0.5, and 1 M, to an upper limit selected from any one of 2, 3, and 4 M where any lower limit may be paired with any upper limit. However, this concentration range will change from salt-to-salt, so the range is used for illustrative purposes only.

Contacting the indium hydroxide with an alkali metal salt solution may be conducted at a temperature in a range of from about 20° C. to about 120° C., such as a lower limit selected from any one of 20, 25, and 50 to an upper limit selected from any one of 60, 75, 100 and 120° C., where any lower limit may be paired with any upper limit.

Contacting the indium hydroxide with an alkali metal salt solution may be conducted for a duration in a range of from about 1 min to about 12 hours, such as a lower limit selected from any one of 1, 10, 30, and 60 min, to an upper limit selected from any one of 2, 5, 10, 12, and 15 h, where any lower limit may be paired with any upper limit.

Contacting the indium hydroxide with an alkali metal salt solution may be conducted by any method known in the art. For example, a simple wetness impregnation may be carried out. In this case, the alkali metal salt solution may be added to solid, powdered indium hydroxide until it fills the indium hydroxide's pores. Alternatively, the solid, powdered indium hydroxide may be added to the alkali metal salt solution and then mixed. The mixing may be done by any method known in the art, for example via a simple mixer such as a stir bar or using a high shear mixer. In this case, the alkali metal from the alkali metal solution diffuses into the indium hydroxide structure.

Upon contacting the indium hydroxide with a solution containing an alkali metal salt, an alkali-impregnated-indium hydroxide is formed. Keeping with FIG. 1A, in step 103 the alkali-impregnated-indium hydroxide is then dried.

The drying of the alkali-impregnated-indium hydroxide may be conducted at a temperature in a range of from about 20° C. to about 120° C., such as a lower limit selected from any one of 20, 25, and 50 to an upper limit selected from any one of 60, 75, 100 and 120° C., where any lower limit may be paired with any upper limit.

The drying of alkali-impregnated-indium hydroxide may be conducted for a range of from about 1 h to about 15 h, such as a lower limit selected from any one of 1, 5, and 7 h to an upper limit selected from any one of 10, 12, and 15 h, where any lower limit may be paired with any upper limit.

The method for producing an alkali-doped In₂O₃ catalyst includes calcinating the alkali-impregnated-indium hydroxide to form In₂O₃ as shown in step 104 of FIG. 1A. As used herein, “calcinating” refers to a process of heating a substance in an oxygen-containing atmosphere to form an oxide. In the present disclosure, alkali-impregnated indium hydroxide is calcinated to form an alkali-doped In₂O₃ catalyst or indium hydroxide is calcinated to form In₂O₃ catalyst.

Calcinating the alkali-impregnated-indium hydroxide to form an alkali-doped In₂O₃ may be conducted at a temperature in a range of from about 250 to about 700° C., such as a lower limit selected from any one of 250, 300, and 400° C., to an upper limit selected from any one of 500, 600, and 700° C., where any lower limit may be paired with any upper limit.

Calcinating the alkali-impregnated-indium hydroxide to form an alkali-doped In₂O₃ may be conducted for a duration in a range of from about 1 h to about 15 h, such as a lower limit selected from any one of 1, 3, 5, and 6 hours, to an upper limit selected from any one of 10, 12, and 15 hours, where any lower limit may be paired with any upper limit.

Calcinating the alkali-impregnated-indium hydroxide to form an alkali-doped In₂O₃ catalyst may be done by any method known to the art, for example the indium hydroxide may be heated in a muffle or tube furnace, or the like, under air or another oxygen-containing atmosphere.

Upon calcinating the alkali-impregnated-indium hydroxide an alkali-doped In₂O₃ is formed.

In another embodiment, the indium hydroxide produced via precipitation in steps 100 and 101 of FIG. 1A as described above may be calcinated to form indium oxide, contacted with an alkali metal salt solution, dried, and, optionally, calcinated a second time to produce an alkali-doped In₂O₃ catalyst.

In FIG. 1A, step 105, indium hydroxide is calcinated to form In₂O₃.

Calcinating the indium hydroxide to form In₂O₃ may be conducted at a temperature in a range of from about 250 to about 700° C., such as a lower limit selected from any one of 250, 300, and 400° C., to an upper limit selected from any one of 500, 600, and 700° C., where any lower limit may be paired with any upper limit.

Calcinating the indium hydroxide to form In₂O₃ may be conducted for a duration in a range of from about 1 to about 15 h, such as a lower limit selected from any one of 1, 3, 5, and 6 hours, to an upper limit selected from any one of 10, 12, and 15 hours, where any lower limit may be paired with any upper limit.

Calcinating the indium hydroxide to form In₂O₃ may be done by any method known to the art, for example the indium hydroxide may be heated in a muffle or tube furnace, or the like, under air or another oxygen-containing atmosphere.

Once In₂O₃ has been formed via calcination of the indium hydroxide, in one or more embodiments, the method for producing an alkali doped In₂O₃ catalyst includes contacting the In₂O₃ with an alkali metal salt solution to form an alkali-doped In₂O₃ catalyst as shown in step 106 of FIG. 1A.

The alkali metal salt solution may be any alkali metal salt solution described previously. The concentration of the alkali metal salt solution may be the concentration of the alkali metal salt solution described previously.

Contacting the In₂O₃ with an alkali metal salt solution may be conducted at a temperature in a range of from about 20° C. to about 120° C., such as a lower limit selected from any one of 20, 25, and 50 to an upper limit selected from any one of 60, 75, 100 and 120° C., where any lower limit may be paired with any upper limit.

Contacting the In₂O₃ with an alkali metal salt solution may be conducted for a duration in a range of from about 1 min to about 12 hours, such as a lower limit selected from any one of 1, 10, 30, and 60 min, to an upper limit selected from any one of 2, 5, 10, 12, and 15 h, where any lower limit may be paired with any upper limit.

Contacting the In₂O₃ with an alkali metal salt solution may be conducted by any method known in the art. For example, a simple wetness impregnation may be carried out. In this case, the alkali metal salt solution may be added to solid, powdered indium hydroxide until it fills the indium hydroxide's pores. Alternatively, the solid, powdered indium hydroxide may be added to the alkali metal salt solution and then mixed. The mixing may be done by any method known in the art, for example via a simple mixer such as a stir bar or using a high shear mixer. In this case, the alkali metal from the alkali metal solution diffuses into the indium hydroxide structure.

Upon contacting the In₂O₃ with a solution containing an alkali metal salt, an alkali-doped In₂O₃ catalyst is formed.

The drying of alkali-doped In₂O₃ catalyst may be conducted at a temperature in a range of from about 20° C. to about 120° C., such as a lower limit selected from any one of 20, 25, and 50 to an upper limit selected from any one of 60, 75, 100 and 120° C., where any lower limit may be paired with any upper limit.

The drying of alkali-doped In₂O₃ catalyst may be conducted for a range of from about 1 h to about 12 h, such as a lower limit selected from any one of 1, 5, and 7 h to an upper limit selected from any one of 10, 12, and 15 h, where any lower limit may be paired with any upper limit.

In yet another embodiment, the method for producing an alkali-doped In₂O₃ catalyst includes mixing an indium salt solution with an alkali metal base to form a precipitated alkali-impregnated-indium hydroxide. The alkali-impregnated-indium hydroxide is separated by filtration or centrifugation, dried, and calcinated to produce an alkali-doped In₂O₃ catalyst.

In FIG. 1B, step 110, an indium salt solution is mixed with an alkali metal base to form a precipitated alkali-impregnated-indium hydroxide.

The alkali metal base may be lithium hydroxide, sodium hydroxide, potassium hydroxide, rubidium hydroxide, cesium hydroxide, or combinations thereof. In one or more embodiments, the alkali metal base may be a mixture of one or more alkali metal bases and/or non-alkali metal bases. The non-alkali metal bases may include, but are not limited to, those described previously.

In one or more embodiments, the base is used to control the pH of the solution to promote the precipitation of indium hydroxide. The pH of solution may be in a range of from about 3 to about 12, such as a lower limit selected from any one of 3, 4, 6 and 7, to an upper limit selected from any one of 9, 10, and 12.

The mixing of an indium salt solution with an alkali metal base may be done using any method known in the art, for example a simple stirring mechanism such as a stir bar, high shear mixer, or a shaker may be used.

The indium salt may be any of the indium salts described previously.

Upon mixing the indium salt solution with the alkali metal base, a precipitated alkali-impregnated-indium hydroxide is formed.

In one or more embodiments the method to produce an alkali-doped In₂O₃ catalyst includes separating, by filtration or centrifugation, and drying the alkali-impregnated-indium hydroxide as shown in step 112 of FIG. 1B.

The drying of the alkali-impregnated-indium hydroxide may be conducted at a temperature in a range of from about 20° C. to about 120° C., such as a lower limit selected from any one of 20, 25, and 50 to an upper limit selected from any one of 60, 75, 100 and 120° C., where any lower limit may be paired with any upper limit.

The drying of alkali-impregnated-indium hydroxide may be conducted for a range of from about 1 h to about 12 h, such as a lower limit selected from any one of 1, 5, and 7 h to an upper limit selected from any one of 10, 12, and 15 h, where any lower limit may be paired with any upper limit.

The method for producing an alkali-doped In₂O₃ catalyst includes calcinating the alkali-impregnated-indium hydroxide to form In₂O₃ as shown in step 114 of FIG. 1B.

Calcinating the alkali-impregnated-indium hydroxide to form an alkali-doped In₂O₃ may be conducted at a temperature in a range of from about 250 to about 700° C., such as a lower limit selected from any one of 250, 300, and 400° C., to an upper limit selected from any one of 500, 600, and 700° C., where any lower limit may be paired with any upper limit.

Calcinating the alkali-impregnated-indium hydroxide to form an alkali-doped In₂O₃ may be conducted for a duration in a range of from about 1 to about 12 h, such as a lower limit selected from any one of 1, 3, 5, and 6 hours, to an upper limit selected from any one of 10, 12, and 15 hours, where any lower limit may be paired with any upper limit.

Calcinating the alkali-impregnated-indium hydroxide to form an alkali-doped In₂O₃ catalyst may be done by any method known to the art, for example the indium hydroxide may be heated in a muffle or tube furnace, or the like, under air or another oxygen-containing atmosphere.

Upon calcinating the alkali-impregnated-indium hydroxide an alkali-doped In₂O₃ is formed.

### Reverse Water Gas Shift Reaction

In general, reverse water gas shift (RWGS) reaction refers to the conversion of CO₂ to CO, as shown in the chemical reaction of Equation 1.

CO₂+H₂ [symbol] CO+H₂O Equation 1

The equilibrium of the RWGS reaction is highly temperature dependent. At high pressure, secondary reactions producing side products shown in Equations 2 and 3, are favorable. Equations 2 and 3 depict methanation reactions, in which carbon oxides and hydrogen are converted to methane and water. Therefore, when CO is the desired product, high reaction temperatures and low reaction pressures are typically required.

CO+3H₂→CH₄+H₂O Equation 2

CO₂+4H₂→CH₄+2H₂O Equation 3

Performing the RWGS reaction with the alkali-doped In₂O₃ catalyst according to embodiments herein provides improved selectivity for enhanced CO production at high pressures (i.e., 50 bar) and moderate temperatures (<500° C.) compared to an In₂O₃ catalyst alone.

FIG. 2 shows an illustrative process to produce CO according to one or more embodiments. FIG. 2 shows a reactor 200 configured to perform an RWGS reaction. The reactor of one or more embodiments may be a fixed-bed continuous flow type reactor, or another suitable reactor known in the art. In one or more embodiments, the reactor 200 may be advantageously operated at a pressure of greater than or equal to 20 bar and a temperature of less than or equal to 600° C. However, as will be appreciated by those skilled in the art, the reactor may be operated at any temperature and pressure suitable to perform the RWGS reaction.

Keeping with FIG. 2, a gas feed 202 containing a mixture of at least hydrogen (H₂) gas and CO₂ gas is fed into the reactor 200. In one or more embodiments, the ratio of H₂ gas to CO₂ gas is in a range having a lower limit of from about 2 mol H₂ to 1 mol CO₂ to an upper limit of from about 60 mol H₂ to 1 mol CO₂, for example, the molar ratio of H₂:CO₂ may be about 2:1, 4:1, 10:1, 20:1, 40:1, or 60:1.

In FIG. 2, the reactor 200 is loaded with a catalyst 204 which is contacted by the gas feed 202. The catalyst 204 may be the alkali-modified In₂O₃ catalyst of one or more embodiments. Upon contacting the gas feed 202 with the catalyst 204 in the reactor 200 at a suitable temperature and pressure, a RWGS reaction of Equation 1 occurs. In one or more embodiments, the RWGS reaction of the reactor 200 has a selectivity to CO of at least 97.9%. The RWGS reaction of reactor 200 may have a selectivity to CH₄ of less than 0.8% and a selectivity to CH₃OH of less than 1.2%.

Keeping with FIG. 2, The products of the RWGS reaction according to one or more embodiments are H₂O 206, side products 208, and CO 210. In one or more embodiments, the side products 208 of FIG. 2 include CH₄ and CH₃OH, according to the reactions of Equations 2 and 3.

The CO stream 210 may be sent to a CO conversion process 212 for further processing. The CO conversion process of FIG. 2 may include methanol synthesis, Fischer-Tropsch synthesis, carbonylation, oxo-alcohol synthesis, dimethyl ether synthesis, hydroformylation, or other processes useful for converting CO.

### Examples

The examples and comparative examples described in the following sections are provided to further illustrate the present invention but are not to be taken as limiting.

### Preparation of Alkali-Modified Indium Oxide Catalyst

Example 1 was prepared by dissolving 6 g of indium nitrate in 100 ml of water. Under stirring, 30% aqueous solution of ammonium hydroxide to the metal solution until pH of 7. The dispersion was stirred for 10 min, and the indium hydroxide was separated by centrifugation. The solid was washed with water, dried for 15 h at 80° C. The resulting indium hydroxide was ground in a mortar.

Example 2 was prepared taking 1.17 g of Example 1 underwent impregnation with a solution containing 0.074 g of NaNO₃ and 0.55 mL of water. The mixture was dried for 1.5 h at 100° C. and then calcinated for 3 h at 350° C. to form a Na-doped In₂O₃ catalyst containing 2 wt. % Na (Na/In₂O₃).

Example 3 was prepared by the same procedure as Example 2, except 0.074 g of NaNO₃ was replaced by 0.052 g of KNO₃ to form a K-doped In₂O₃ catalyst containing 2 wt. % K (K/In₂O₃).

Example 4 was prepared by the same procedure as Example 2, 0.074 g of NaNO₃ was replaced by 0.035 g of RbNO₃ to form a Rb-doped In₂O₃ catalyst containing 2 wt. % Rb (Rb/In₂O₃).

Example 5 was prepared by the same procedure as Example 2, except 0.074 g of NaNO₃ was replaced by 0.029 g of CsNO₃ to form a Cs-doped In₂O₃ catalyst containing 2 wt. % Cs (Cs/In₂O₃).

Comparative Example 1 was 99.9% commercial indium oxide catalyst acquired by Sigma-Aldrich (In₂O₃-Comm).

Comparative Example 2 was prepared impregnating 0.98 g of commercial indium oxide with a solution containing 0.074 g of NaNO₃ and 0.77 mL of water. The mixture was dried for 1.5 h at 100° C. and then calcinated for 3 h at 350° C. to form a Na-doped In₂O₃ catalyst containing 2 wt. % Na (Na/In₂O₃-Comm).

Comparative Example 3 was prepared by the same method as Comparative Example 2, except 0.074 g of NaNO₃ was replaced by 0.052 g of KNO₃ to form a K-doped In₂O₃ catalyst containing 2 wt. % K (K/In₂O₃-Comm).

Comparative Example 4 was prepared by the same method as Comparative Example 2, except 0.074 g of NaNO₃ was replaced by 0.035 g of KNO₃ to form a Rb-doped In₂O₃ catalyst containing 2 wt. % Rb (Rb/In₂O₃-Comm).

Comparative Example 5 was prepared by the same method as Comparative Example 2, 0.074 g of NaNO₃ was replaced by 0.029 g of KNO₃ to form a Cs-doped In₂O₃ catalyst containing 2 wt. % Cs (Cs/In₂O₃-Comm).

### Reverse Water Gas Shift Reaction of Examples 1-5 and Comparative Examples 1-5

Examples 1-5 and Comparative Examples 1-5 were used as a catalyst for a RWGS reaction to produce carbon monoxide (CO). The reaction bed was loaded with a catalyst selected from Examples 1-5 or Comparative Examples 1-5 and the reaction was conducted at 400° C. and 50 bar. A gas feed containing hydrogen/carbon dioxide (H₂/CO₂) at a 4:1 molar ratio was fed into a parallel reactor Flowrence® from Avantium reactor at a gas hourly space velocity (GHSV) of 15,000 mL/g/h.

Catalytic tests were conducted using the parallel reactor Flowrence® from Avantium. The system distributed one mixed feed gas flow over 16 channels, ensuring a relative standard deviation of 2%. The mixed feed gas consisted of approximately 20 vol % of CO₂ and 80 vol % of H₂. Additionally, 2 mL/min of He was added to the feed as an internal standard. The target flow rate per channel was set at 15000 mL/g/h. Quartz reactors measuring 30 cm in length with an internal diameter of 2 pm were used.

To ensure an isothermal zone for the placement of the catalytic bed, the tubes were initially filled with a 9.5 cm bed of coarse SiC (particle grit 40, 300 pi). Subsequently, 50 mg of catalyst particles within the range of 150 μm and 250 pm were loaded. As a control, a blank test was conducted with a reactor filled solely with SiC after every 45 catalytic runs.

Before introducing the reaction mixture, all samples were pretreated in-situ with a pure N₂ atmosphere for approximately 1 h at 400° C. The tubes were then pressurized to approximately 50 bar using a membrane-based pressure controller that operated with N₂ pressure. The analysis of the resulting products was performed using an Agilent 7890B chomatograph equipped with two loops. One loop was connected to the Column 5 Flaysep Q 6 Ft G3591-80013 and TCD, while the second loop was connected to the Gaspro 30M, 0.32 MM OD column followed by FID.

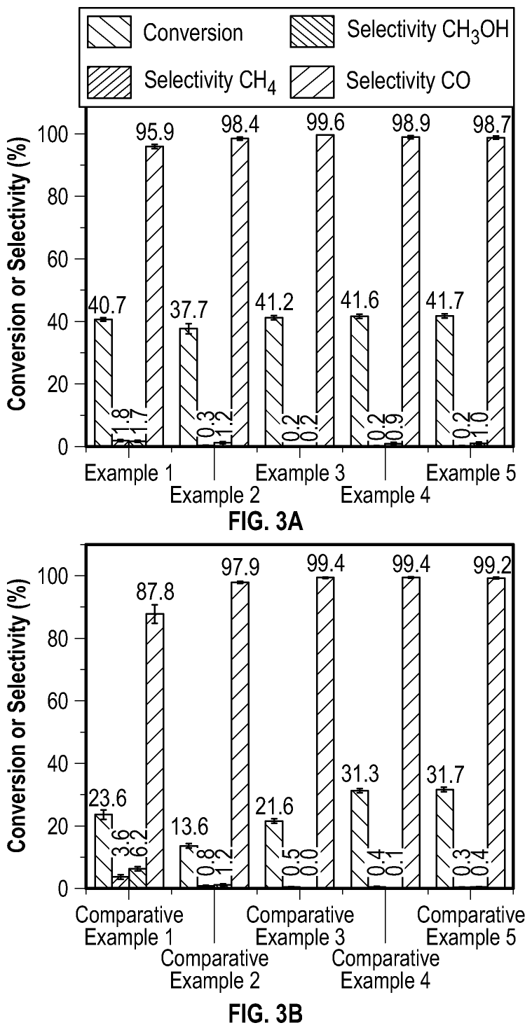

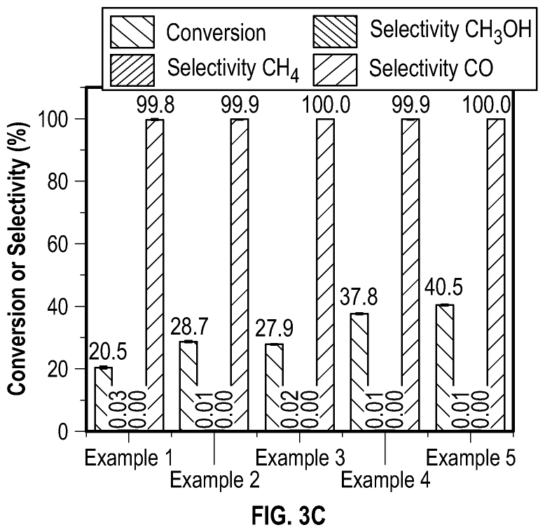

Results for the RWGS reaction of Examples 1-5 and Comparative Examples 1-5 at 400° C. 50 bar, and 15,000 mL/g/h H₂/CO₂ at a 4:1 molar ratio feed gas are shown in FIGS. 3A and 3B. The percent conversion of CO₂ and percent selectivity to methane (CH₄), methanol (CH₃OH), and CO for the reaction using the catalysts of Examples 1-5 and Comparative Examples 1-5 are shown in FIG. 3A and FIG. 3B, respectively. As shown in FIG. 3A, using In₂O₃ as a catalyst (Example 1) led to a conversion rate of 40.7% of CO₂, and selectivities of 95.9% to CO, 1.8% to CH₄, and 1.7% to CH₃OH. Doping Example 1 with alkali metals led to increased CO selectivity and reduced formation of CH₄ and CH₃OH, as indicated by the results for Examples 2-5 shown in FIG. 3A. For example, K/In₂O₃ (Example 3) reached 41.2% CO₂ conversion and selectivities of 99.6% to CO and 0.2% to both CH₄ and CH₃OH. Results for Comparative Examples 1-5 are shown in FIG. 3B. The reaction with Comparative Example 5 (Rb/In₂O₃-Comm) showed the best results of the Comparative Examples tested, with 31.7% conversion to CO₂, and selectivities of 99.2% to CO, 0.3% to CH₄, and 0.4% to CH₃OH. Overall, alkali-doped In₂O₃ catalysts led to better performance than In₂O₃ alone in the RWGS reaction, as shown by the relatively higher CO₂ conversion and CO selectivity and lower selectivities to CH₄ and CH₃OH, for both the synthesized In₂O₃ catalyst (Example 1 compared to Examples 2-5) and the commercial In₂O₃ catalyst (Comparative Examples 1 compared to Comparative Examples 2-5) shown in FIGS. 3A and 3B, respectively. In addition, the overall performance of Comparative Examples 1-5 was inferior to the performance of Examples 1-5, as shown by the relatively higher CO₂ conversion and CO selectivity and lower selectivities to CH₄ and CH₃OH of Examples 1-5 (FIG. 3A) compared to Comparative Examples 1-5 (FIG. 3B).

FIG. 3C shows RWGS reaction of Examples 1-5 at ambient pressure. Because one of the main objectives of the alkali-doped In₂O₃ catalysts according to one or more embodiments was to enable a RWGS reaction at high pressure. Examples 1-5 were also used as a catalyst for a RWGS reaction to produce carbon monoxide (CO) at the same reactor conditions as those in FIG. 3A, except the pressure was ambient instead of 50 bar. The temperature of 400° C. and gas feed flowrate and molar ratio of 15,000 mL/g/h were kept constant compared to the results of FIG. 3A.

In FIG. 3C, the CO₂ conversion for Examples 1-5 ranges from about 20% to about 40% when the RWGS reaction is run at ambient pressure. In contrast, FIG. 3A shows that the CO₂ conversion for each of Examples 1-5 is about 40% when the RWGS reaction is run at a pressure of 50 bar. The results in FIG. 3C compared to FIG. 3A show that the alkali-doped In₂O₃ catalysts according to one or more embodiments (i.e., Examples 1-5) perform better at the high reactor pressure of 50 bar versus ambient reactor pressure.

The highest performing catalyst of the example reaction at 50 bar, Example 3 (K/In₂O₃), was subjected to further testing in which the RWGS reaction was conducted at various reaction conditions. For comparison, Example 1 was run at the same various reaction conditions. Examples 1 and 3 were used as a catalyst for a RWGS reaction to produce carbon monoxide (CO) in which the reaction bed was loaded Example 1 or Example 3 catalyst, and the reaction was conducted at various temperatures, pressures, and feed gas GHSV conditions, as listed in Tables 1-1 and 1-2. In all reactions, the gas feed contained hydrogen/carbon dioxide (H₂/CO₂) at a 4:1 molar. The same reactor type was used as described in previous examples.

TABLE 1

| | Reaction | Reaction | Reaction | Reaction | Reaction | Reaction |
|---|---|---|---|---|---|---|
| Conditions | 1 | 2 | 3 | 4 | 5 | 6 |
| Catalyst | Example | Example | Example | Example | Example | Example |
| | 3 | 3 | 3 | 3 | 3 | 3 |
| Pressure (bar) | 50 | 50 | 50 | 50 | 50 | 50 |
| Temperature | 400 | 400 | 400 | 450 | 350 | 350 |
| (° C.) | | | | | | |
| Feed gas | 15,000 | 18,000 | 7,500 | 7,500 | 15,000 | 7,500 |
| GHSV | | | | | | |
| (mL/g/h) | | | | | | |

TABLE 2

| | Reaction | Reaction | Reaction | Reaction | Reaction | Reaction |
|---|---|---|---|---|---|---|
| Conditions | 7 | 8 | 9 | 10 | 11 | 12 |
| Catalyst | Example | Example | Example | Example | Example | Example |
| | 1 | 1 | 1 | 1 | 1 | 1 |
| Pressure (bar) | 50 | 50 | 50 | 50 | 50 | 50 |
| Temperature | 400 | 400 | 400 | 450 | 350 | 350 |
| (° C.) | | | | | | |
| Feed gas | 15,000 | 18,000 | 7,500 | 7,500 | 15,000 | 7,500 |
| GHSV | | | | | | |
| (mL/g/h) | | | | | | |

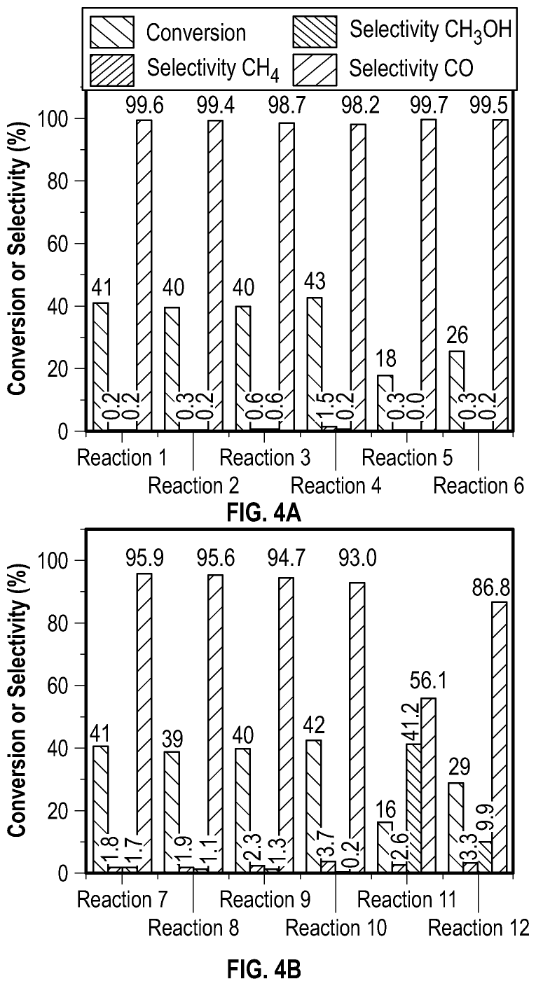

Results for RWGS reactions at the various reaction conditions listed in Tables 1 and 2 are shown with Example 3 as the catalyst in FIG. 4A and Example 1 as the catalyst in FIG. 4B. Increasing the feed gas GHSV from 15,000 to 18,000 mL/g/h or decreasing it to 7500 mL/g/h at constant reaction temperature and pressure did not have significant effect on the catalyst performance of Example 3, as shown by Reactions 1-3 in FIG. 4A and of catalyst Example 1, as shown by Reactions 7-9 in FIG. 4B. Increasing the temperature from 400 to 450° C. at constant pressure and 7,500 mL/g/h feed gas GHSV led to a slightly higher selectivity to CH₄ and decrease of CO selectivity, for both Example 3, as shown by Reactions 3-4 in FIG. 4A and of catalyst Example 1, as shown by Reactions 9-10 in FIG. 4B. For catalyst Example 3, decreasing the temperature from 400° C. to 350° C. at constant pressure and constant gas GHSV had no significant effect on the selectivity of CO, CH₄, and CH₃OH but the conversion of CO₂ significantly decreased with decreasing temperature, as shown by Reactions 1 and 5 (15,000 mL/g/h feed gas GHSV) and Reactions 3 and 6 (7,500 mL/g/h feed gas GHSV) in FIG. 4A. Specifically, the CO₂ conversion decreased from about 41% to about 18% when the reaction temperature decreased from 400° C. to 350° C. at constant pressure and 15,000 mL/g/h feed gas GHSV and CO₂ conversion decreased from about 40% to about 26% when the reaction temperature decreased from 400° C. to 350° C. at constant pressure and 15,000 mL/g/h feed gas GHSV. In contrast, for catalyst Example 1, decreasing the temperature from 400° C. to 350° C. at constant pressure and constant gas GHSV led to a reduction in the selectivity of CO, CH₄, and CH₃OH. Furthermore, the conversion of CO₂ significantly decreased with decreasing temperature, as shown by Reactions 7 and 11 (15,000 mL/g/h feed gas GHSV) and Reactions 8 and 12 (7,500 mL/g/h feed gas GHSV) in FIG. 4B. In conclusion, varying reaction conditions, such as temperature and feed gas GHSV, had less effect on the selectivity of CO, CH₄, and CH₃OH and the conversion of CO₂ when an alkali-doped indium oxide catalyst (Example 3 shown in FIG. 4A) was used as compared to an indium oxide catalyst (Example 1 shown in FIG. 4B). Furthermore, alkali-doped indium oxide can operate at temperatures as low as 350° C. with negligible selectivity to methane and methanol.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phase “comprising,” it is understood that we also contemplate the same composition or group of elements with transitional phases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A composition comprising:
an indium oxide catalyst comprising an alkali dopant.

2. The composition of claim 1, wherein the alkali dopant comprises an alkali cation selected from the group consisting of Li⁺, Na⁺, K⁺, Rb⁺, Cs⁺ and Fr⁺.

3. The composition of claim 1, wherein the composition comprises 0.5 to 10 wt. % of the alkali dopant.

4. A method for producing an indium oxide catalyst comprising an alkali dopant, comprising:
mixing a solution of an indium salt with a base to form precipitated indium hydroxide;
contacting the precipitated indium hydroxide with a solution comprising an alkali metal salt to produce an indium hydroxide solution; and
calcinating the indium hydroxide solution to form indium oxide; and
thereby forming the indium oxide catalyst comprising an alkali dopant.

5. The method of claim 4, wherein the solution comprising an alkali metal salt comprises an alkali cation selected from the group consisting of Li⁺, Na⁺, K⁺, Rb⁺, Cs⁺ and Fr⁺.

6. The method of claim 4, wherein the solution comprises an alkali metal salt has a concentration of 0.01 M to 4 M.

7. The method of claim 4, wherein the indium salt comprises an indium compound selected from the group consisting of indium nitrate, indium acetate, indium chloride, indium oxalate, and indium sulfate under any hydration form.

8. The method of claim 4, wherein the base is selected from the group consisting of ammonium hydroxide, an alkali metal hydroxide, or a quaternary ammonium hydroxide, and mixtures thereof.

9. The method of claim 4, wherein calcinating the precipitated indium hydroxide to form indium oxide further comprises heating the precipitated indium hydroxide in an oxygen-containing atmosphere to form the indium oxide catalyst comprising an alkali dopant.

10. The method of claim 4, wherein calcinating the precipitated indium hydroxide to form indium oxide occurs at a temperature in a range of from 250° C. to 700° C.

11. The method of claim 5, wherein calcinating the precipitated indium hydroxide to form indium oxide occurs for a duration in a range of from 1 h to 15 h.

12. A process to produce carbon monoxide, comprising:
contacting, in a reactor, a gas feed with a catalyst, wherein the catalyst comprises;
an indium oxide catalyst comprising an alkali dopant.

13. The process of claim 12, wherein the catalyst has a selectivity to carbon monoxide of at least 97.9%.

14. The process of claim 12, wherein the catalyst has a selectivity to methane of less than 0.8%.

15. The process of claim 12, wherein the catalyst has a selectivity to methanol of less than 1.2%.

16. The process of claim 12, wherein the process takes place at a temperature of less than or equal to 600° C.

17. The process of claim 12, wherein the process takes place at a pressure of less than or equal to 50 bar.

18. The process of claim 12, wherein the gas feed comprises a mixture of at least hydrogen gas and carbon dioxide gas.

19. The process of claim 12, wherein the gas feed comprises a molar ratio of from 2:1 mol hydrogen to mol carbon dioxide to 60:1 mol hydrogen to mol carbon dioxide.
